(19) United States
(12) Patent Application Publication
(10) Pub. No.: US 2020/0099950 A1
(43) Pub. Date: Mar. 26, 2020

(54) PROCESSING DEVICES AND CONTROL METHODS THEREFOR

(71) Applicant: SAMSUNG ELECTRONICS CO., LTD., Suwon-si (KR)

(72) Inventors: Sang-kwon NA, Seoul (KR); Ki-won YOO, Seoul (KR)

(73) Assignee: SAMSUNG ELECTRONICS CO., LTD., Suwon-si (KR)

(21) Appl. No.: 16/495,469

(22) PCT Filed: Feb. 20, 2018
(86) PCT No.: PCT/KR2018/002048

§ 371 Date: Sep. 19, 2019

(30) Foreign Application Priority Data
May 31, 2017 (KR) 10-2017-0067744

(51) Int. Cl. H04N 19/517; H04N 19/423; H04N 19/46; H04N 19/119; H04N 19/176

(52) U.S. Cl. CPC H04N 19/517; H04N 19/423; H04N 19/176; H04N 19/119; H04N 19/46

(57) ABSTRACT

Provided is a processing device. The processing device includes a memory storing a video content, and a processor to divide a frame forming the video content into a plurality of coding units, and generate an encoded frame by performing encoding for each of the plurality of coding units, and the processor may add information including a motion vector that is obtained in the encoding process for each of the plurality of coding units to the encoded frame.

### TECHNICAL FIELD

The disclosure relates to processing devices and control methods therefor and, more particularly, to processing devices performing inter coding and intra coding and control methods therefor.

### BACKGROUND ART

Wireless video content transmission may have packet loss and error in the data transmission process within a predetermined time. In particular, in the case of video mirroring where real-time and low-latency are important, restoration via packet retransmission may be restricted.

As a method of restoring this transmission error, a frame/sub-frame duplication method and a context-based error concealment/restoration method, or the like, are used.

The frame/sub-frame duplication method may include determining whether an error has occurred through a cyclic redundancy check (CRC), and if an error has occurred, repeatedly outputting a last normal transmitted image (frame) or copying and outputting a portion of an area (sub-frame) of the error image to an area corresponding to the last normal transmitted image.

In the meantime, the frame/sub-frame duplication method is prominent in view quality degradation due to low restoration accuracy and freezing artifacts due to repeated playback of previous images, and the transmission delay is always accompanied in the CRC checking process for the bit-stream in a frame or sub-frame unit. In particular, in the case where an error occurs in a continuous frame, there is a problem in that the freezing artifact increases due to the continuously repeated reproduction of the same frame.

The context-based error concealment/restoration method uses the mode and pixel information of neighboring blocks to predict and restore a pixel of a lost area. Here, a motion vector (MV) of the neighboring blocks and the pixel information of the normally-restored frames are used to predict and restore the pixels of the lost areas, or the mode, pixel of the neighboring blocks, and the pixel information of the previous normally-restored frame are utilized to predict and restore the pixel of the lost area through the motion prediction process in the decoder.

However, the context-based error concealment/restoration method has a problem that the accuracy is reduced, since the reference MV is generated only through the surrounding MV, and that an error of the incorrectly restored image is spread to the last frame. In addition, the MV correction technique using the neighboring pixels on the decoder side requires high computational complexity, and when there is no available neighboring pixel or MV information, the deterioration of the restoration quality is spread in the process of using the error-restored data in a serial manner.

Accordingly, a method for restoring an error even under temporal constraints in accordance with wireless transmission of a video content has been developed to provide a high quality image.

### DISCLOSURE

### Technical Problem

Accordingly, the objective of the disclosure is to provide processing devices to improve restoration efficiency of a pixel area in which an error occurs in a frame forming a video content and control methods therefor.

### Technical Solution

According to an embodiment, a processing device includes a memory storing a video content, and a processor to divide a frame forming the video content into a plurality of coding units, and generate an encoded frame by performing encoding for each of the plurality of coding units, and the processor may add information including a motion vector that is obtained in the encoding process for each of the plurality of coding units to the encoded frame.

The additional information may include a motion vector for all of the plurality of the coding units.

The additional information may be included in a reserved area of a header that corresponds to the encoded frame.

The processor may search for, from a current frame including a current coding unit and a predetermined number of neighboring frames based on the current frame, a motion vector corresponding to the current coding unit, and add, to the additional information, identification information of at least one frame including a pixel area corresponding to the searched motion vector among the current frame and the neighboring frames.

The processor may search for a motion vector corresponding to a current coding unit, and based on a pixel value of a corresponding position between a pixel area corresponding to the searched motion vector and the current coding unit satisfying a preset condition, add, to the additional information, information to use a motion vector of a neighboring coding unit of the current coding unit.

The processor may, based on a motion vector for at least two coding units being identical in one frame, add, to the additional information, position information on the at least two coding units and a motion vector of one of the at least two coding units.

The processor may, based on regularity between the motion vectors for all of the plurality of coding units being detected, add, to the additional information, information corresponding to the detected regularity.

According to an embodiment, a processing device includes a memory storing an encoded video content, and a processor to generate a decoded frame by performing decoding for an encoded frame forming the encoded video content in a coding unit, and the encoded video content may be added with additional information including a motion vector obtained in an encoding process for each of a plurality of coding units forming the encoded frame by each of the encoded frames, and the processor may, based on decoding of a current coding unit not being possible, perform decoding by obtaining a motion vector for the current coding unit from the additional information and replacing the current coding unit with a pixel area corresponding to the obtained motion vector [symbol] .

The additional information may include a motion vector for all of the plurality of coding units.

The additional information may be included in a reserved area of a header corresponding to the encoded frame.

The additional information may include identification information of at least one frame including a pixel area corresponding to the motion vector, and the processor may, based on decoding of the current coding unit not being possible, perform decoding by obtaining a motion vector and identification information for the current coding unit from the additional information and replacing the current coding unit with a pixel area corresponding to the obtained motion vector in the frame corresponding to the obtained identification information.

The additional information may include information to use a motion vector of a neighboring coding unit of the current coding unit, and the processor may, based on decoding of the current coding unit not being possible, perform decoding by obtaining information to use a motion vector of a neighboring coding unit of the current coding unit from the additional information, and replacing the current coding unit with a pixel area corresponding to a motion vector of the neighboring coding unit based on the obtained information.

The additional information may include position information of at least two coding units of which a motion vector is identical and a motion vector of one of the at least two coding units, and the processor may, based on decoding of the current coding unit not being possible, perform decoding by replacing the current coding unit with a pixel area corresponding to a motion vector of the at least two coding units based on the position information.

The additional information may include information corresponding to regularity between motion vectors for all of the plurality of coding units, and the processor may, based on decoding of the current coding unit not being possible, perform decoding by obtaining a motion vector corresponding to the current coding unit based on information corresponding to the regularity and replacing the current coding unit with a pixel area corresponding to the obtained motion vector.

According to an embodiment, a control method of a processing device includes dividing a frame forming a video content into a plurality of coding units, and generating an encoded frame by performing encoding for each of the plurality of coding units, and the generating the encoded frame may include adding information including a motion vector that is obtained in the encoding process for each of the plurality of coding units to the encoded frame.

The additional information may include a motion vector for all of the plurality of the coding units.

The additional information may be included in a reserved area of a header that corresponds to the encoded frame.

The generating the encoded frame may include searching for, from a current frame including a current coding unit and a predetermined number of neighboring frames based on the current frame, a motion vector corresponding to the current coding unit, and adding, to the additional information, identification information of at least one frame including a pixel area corresponding to the searched motion vector among the current frame and the neighboring frames.

The generating the encoded frame may include searching for a motion vector corresponding to a current coding unit, and, based on a pixel value of a corresponding position between a pixel area corresponding to the searched motion vector and the current coding unit satisfying a preset condition, adding, to the additional information, information to use a motion vector of a neighboring coding unit of the current coding unit.

According to an embodiment, a control method of a processing device includes performing decoding for an encoded frame forming the encoded video content in a coding unit and generating a decoded frame by disposing the decoded plurality of coding units in a preset direction, and the encoded video content may be added with additional information including a motion vector obtained in an encoding process for each of a plurality of coding units forming the encoded frame by each of the encoded frames, and the performing the decoding may, based on decoding of a current coding unit not being possible, include performing decoding by obtaining a motion vector for the current coding unit from the additional information and replacing the current coding unit with a pixel area corresponding to the obtained motion vector.

### Advantageous Effect

As described above, according to various embodiments, the processing devices add a motion vector for each of a plurality of coding units forming a frame to an encoded frame, and if an error occurs, the processing devices use the motion vector to improve restoration efficiency.

### BRIEF DESCRIPTION OF THE DRAWINGS

FIG. 1 is a block diagram illustrating a processing device performing encoding, to facilitate understanding of the disclosure;

FIG. 2 is a block diagram illustrating a processing device performing decoding, to facilitate understanding of the disclosure;

FIG. 3 is a simplified block diagram to describe a processing device performing encoding according to an embodiment;

FIG. 4 is a view to describe a method for generating additional information according to an embodiment;

FIG. 5 is a view to describe a method for generating additional information according to another embodiment;

FIG. 6A and FIG. 6B are views to describe a case where occlusion occurs according to an embodiment;

FIG. 7 is a view to describe a method for reducing data amount of additional information according to an embodiment;

FIG. 8 is a simplified block diagram to describe a processing device performing decoding according to an embodiment;

FIG. 9 is a flowchart to describe a control method of a processing device performing encoding according to an embodiment; and

FIG. 10 is a flowchart to describe a control method of a processing device performing decoding according to an embodiment.

### DETAILED DESCRIPTION OF EMBODIMENTS

Hereinbelow, the disclosure will be described in greater detail with reference to the drawings.

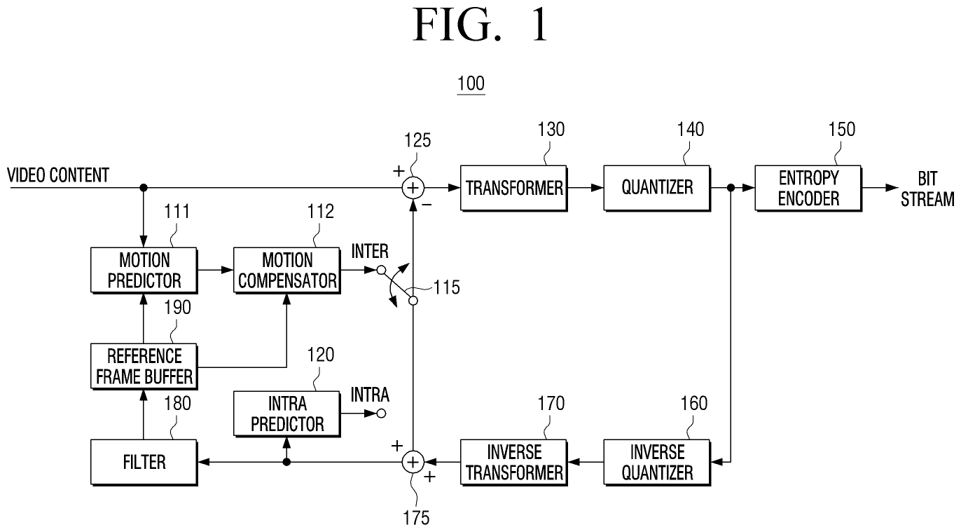

FIG. 1 is a block diagram illustrating a configuration of a processing device 100 that performs encoding for better understanding of the disclosure. As illustrated in FIG. 1, the processing device 100 includes a motion predictor 111, a motion compensator 112, an intra predictor 120, a switch 115, a subtractor 125, a transformer 130, a quantizer 140, an entropy encoder 150, an inverse quantizer 160, an inverse transformer 170, an adder 175, a filter 180, and a reference frame buffer 190. Here, each functional unit may be implemented with at least one hardware form (for example: at least one processor), but may also be implemented in at least one software or program form.

The processing device 100 is a device that encodes video content and transforms the video content to another signal form. Here, the video content includes a plurality of frames, and each frame may include a plurality of pixels. For example, the processing device 100 may be a device for compressing raw data that has not been processed. Alternatively, the processing device 100 may be a device that changes the pre-encoded data into another signal form.

The processing device 100 may divide each frame into a plurality of blocks to perform encoding. The processing device 100 may perform encoding via temporal or spatial prediction, transformation, quantization, filtering, entropy encoding, or the like, in a block unit.

The prediction means generating a prediction block that is similar to the target block to be encoded. Here, the unit of the target block to be encoded may be defined as a prediction unit (PU), and the prediction is divided into temporal prediction and spatial prediction.

Temporal prediction means prediction between screens (inter prediction). The processing device 100 may store some reference frames having a high correlation with the frame to be currently encoded, and perform inter prediction using the reference frames. That is, the processing device 100 may generate a prediction block from a reference frame restored after being encoded at a previous time. In this case, it is said that the processing device 100 is said to perform inter-encoding.

In the case of inter-encoding, the motion predictor 111 may search for a block having a highest temporal correlation with the target block in a reference frame stored in the reference frame buffer 190. The motion predictor 111 may interpolate the reference frame and search for a block having the highest temporal correlation with the target block in the interpolated frame.

Here, the reference frame buffer 190 is a space for storing the reference frame. The reference frame buffer 190 is used only when performing inter prediction, and may have stored some reference frames having a high correlation with the frame to be currently encoded. The reference frame may be a frame generated by sequentially transforming, quantizing, inverse quantizing, inverse transform, and filtering a residual block to be described later. That is, the reference frame may be a frame restored after encoding.

The motion compensator 112 may generate a prediction block based on the motion information for the block having the highest temporal correlation with the target block found in the motion predictor 111. Here, the motion information may include a motion vector, a reference frame index, or the like.

The spatial prediction refers to intra prediction. The intra predictor 120 may perform spatial prediction from restored adjacent pixels after encoding in the current frame to generate a prediction value for the target block. In this case, it is said that the processing device 100 performs intra encoding.

The inter encoding or intra encoding may be determined in a coding unit (CU). Here, the coding unit may include at least one prediction unit. When a method for encoding prediction is determined, a position of the switch 115 may be changed to correspond to the encoding prediction method.

The restored reference frame after encoding in the temporal prediction may be a frame to which filtering is applied, but the restored adjacent pixels after encoding in the spatial prediction may be pixels to which filtering is not applied.

The subtractor 125 may generate a residual block by calculating a difference between a target block and a prediction block obtained from temporal prediction or spatial prediction. The residual block may be a block from which a lot of redundancy has been eliminated by the prediction process, but it may be a block including information to be encoded, as the prediction is not done perfectly.

The transformer 130 may transform the residual block after intra prediction or inter prediction to remove spatial redundancy and output a transform coefficient of the frequency domain. At this time, the unit of transform is transform unit (TU) and may be determined independently of the prediction unit. For example, a frame including a plurality of residual blocks may be divided into a plurality of transform units independent of the prediction unit, and the transformer 130 may perform transformation on a respective transform unit. The division of the transform unit may be determined according to bit rate optimization.

The embodiment is not limited thereto, and the transform unit may be determined in connection with at least one of the coding unit and the prediction unit.

The transformer 130 may perform transformation to focus energy of each transform unit to a specific frequency domain. For example, the transformer 130 may perform transformation based on discrete cosine transform (DCT) for each transform unit and concentrate data into a low-frequency domain. Alternatively, the transformer 130 may perform transformation based on discrete Fourier transform (DFT) or discrete sine transform (DST).

The quantizer 140 may perform quantization on the transform coefficients, and approximate the transform coefficients to predetermined number of representative values. In other words, the quantizer 140 may map input values in a specific range to one representative value. In this process, a high-frequency signal which is not easily recognized by a person may be removed, and loss of information may occur.

The quantizer 140 may use one of uniform quantization and non-uniform quantization methods according to the probability distribution of the input data or the purpose of quantization. For example, when the probability distribution of the input data is uniform, the quantizer 140 may use the uniform quantization method. Alternatively, the quantizer 140 may use a non-uniform quantization method when the probability distribution of the input data is not uniform.

The entropy encoder 150 may reduce the amount of data by variably allocating the length of the symbol according to the occurrence probability of the symbol with respect to the data input from the quantizer 140. That is, the entropy encoder 150 may generate a bit stream by expressing the input data as a bit string having a variable length consisting of 0 and 1 based on a probability model.

For example, the entropy encoder 150 may express input data by assigning a small number of bits to a symbol having a high probability of occurrence, and assigning a large number of bits to a symbol having a low probability of occurrence. Accordingly, the size of the bit string of the input data may be reduced, and the compression performance of video encoding may be improved.

The entropy encoder 150 may perform entropy encoding by a variable length coding such as Huffman coding and exponential-golomb coding or arithmetic coding.

The inverse quantizer 160 and inverse transformer 170 may receive the quantized transform coefficients to inverse quantize each of the quantized transform coefficients and generate the restored residual block.

The adder 175 may generate the restored block by adding the restored residual block and the prediction block obtained from temporal prediction or spatial prediction.

The filter 180 may apply at least one of a deblocking filter, a sample adaptive offset (SAO), and an adaptive loop filter (ALF) to the restored image. The filtered restored frame may be stored in the reference frame buffer 190 and used as a reference frame.

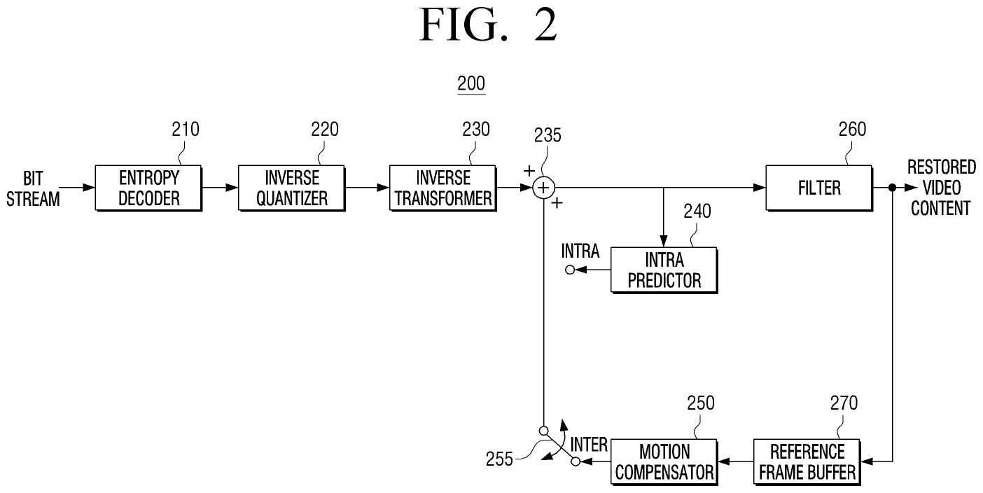

FIG. 2 is a block diagram illustrating a processing device 200 performing decoding, to facilitate understanding of the disclosure. As shown in FIG. 2, the processing device 200 includes an entropy decoder 210, an inverse quantizer 220, an inverse transformer 230, an adder 235, an intra predictor 240, a motion compensator 250, a switch 255, a filter 260, and a reference frame buffer 270.

The processing device 200 that performs decoding may receive a bit stream generated by the processing device 100 that performs encoding, perform decoding, and reconstruct a video. The processing device 200 may perform decoding by passing though entropy decoding, inverse quantization, inverse transformation, filtering, etc. on a block unit.

The entropy decoder 210 may perform entropy decoding of the input bit stream to generate quantized transform coefficients. In this case, the entropy decoding method may be a method in which the method used by the entropy decoder 150 of FIG. 1 is reversely applied.

The inverse quantizer 220 may perform inverse quantization by receiving a quantized transform coefficient. That is, according to the operations of the quantizer 140 and the inverse quantizer 220, an input value of a specific range is changed to any one reference input value within a specific range. In this process, an error as much as a difference between the input value and any one reference input value may occur.

The inverse transformer 230 inversely transforms the data output from the inverse quantizer 220, and may perform inverse transformation by applying the method used by the transformer 130 in an inverse manner. The inverse transformer 230 may generate a restored residual block by performing an inverse transformation.

The adder 235 may generate the restored block by adding the restored residual block and the prediction block. Here, the prediction block may be a block generated through inter encoding or intra encoding.

In the case of inter decoding, the motion compensator 250 may receive or derive (derive from a neighboring block) motion information about a target block to be decoded from the processing device 100 that performs encoding, and generate the prediction block based on the received or derived motion information. Here, the motion compensator 250 may generate a prediction block from a reference frame stored in the reference frame buffer 270. The motion information may include a motion vector for the block having the highest temporal correlation with the target block, a reference frame index, or the like.

Here, the reference frame buffer 270 may store a portion of the reference frame having a high correlation with the frame to be decoded. The reference frame may be a frame generated by filtering the restored block described above. That is, the reference frame may be a frame in which the bit stream generated in the processing device 100 performing the encoding is restored. In addition, the reference frame used in the processing device 200 performing the decoding may be the same as the reference frame used in the processing device 100 performing the encoding.

In case of the intra decoding, the intra predictor 240 may perform spatial prediction from the restored neighboring pixels in the present frame and generate a prediction value for the target block.

A location of the switch 255 may change according to a prediction method for decoding of the target block.

The filter 260 may apply at least one of a deblocking filter, SAO, or ALF to the restoration frame. The filtered restoration frame may be stored in the reference frame buffer 270 and utilized as a reference frame.

In the meantime, the processing device 200 may further include a parser (not shown) that parses information related to an encoded frame included in the bit stream. The parser may include the entropy decoder 210 and may be included in the entropy decoder 210.

As described above, the processing device 100 that performs encoding may compress the data of the video through an encoding process and transmit the compressed data to the processing device 200 that performs decoding. The processing device 200 that performs decoding may reconstruct the video content by decoding the compressed data.

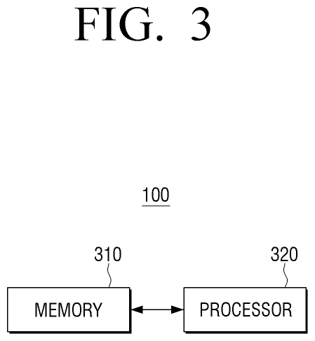

FIG. 3 is a simplified block diagram to describe a processing device 100 performing encoding according to an embodiment.

As illustrated in FIG. 3, the processing device 100 includes a memory 310 and a processor 320.

The memory 310 may be provided separately from the processor 320 and may be implemented as a hard disk, a non-volatile memory, a volatile memory, or the like. The memory 310 may be implemented as an internal memory of the processor 320.

The memory 310 may store a video content, a reference frame, or the like. Here, the reference frame may be a restored frame of a frame encoded by the processor 320.

Meanwhile, the memory 310 may store all of the video content, or may store a portion of the video content streamed from an external server or the like on a real-time basis. In this case, the memory 310 may store only a portion of the video content that is received in real time, and delete the data of the video content of which encoding has been completed.

The processor 320 controls overall operation of the processing device 100.

The processor 320 may divide a frame forming the video content into a plurality of coding units, and generate an encoded frame by performing encoding for each of the plurality of coding units.

Here, the plurality of coding units may be a largest coding unit (LCU). The embodiment is not limited thereto, and the processor 320 may divide the frame in a plurality of coding units of any number of different sizes. Further, the size of the plurality of coding units may be different from each other.

The processor 320 may add additional information including a motion vector that is obtained in the encoding process for each of the plurality of coding units to an encoded frame.

Specifically, the processor 320 may perform temporal prediction and spatial prediction for the current coding unit. The processor 320 may determine whether to perform intra encoding or inter encoding for the current coding unit based on errors by temporal prediction and errors by spatial prediction.

The processor 320 may separately generate additional information including a motion vector of the current coding unit regardless of the encoding method of the current coding unit. For example, the processor 320 may include additional information in a reserved area of a header corresponding to the encoded frame. Here, the header may be a supplemental enhancement information (SEI) header.

Alternatively, the processor 320 may include additional information in a separate storage area instead of the header. For example, the processor 320 may store additional information by generating an additional area other than the header and data areas. In this case, the processing device 200 that performs decoding, which will be described later, may also store information about a location where additional information is stored.

The processor 320 may separately generate additional information, including the motion vector of the current coding unit, even though the current coding unit is intra-encoded. In the related art, if the current coding unit is intra-encoded, the motion vector of the current coding unit is not separately stored and deleted.

When the current coding unit is inter-coded, the processor 320 may store the inter-encoded current coding unit and the motion vector in the data area, and may separately generate additional information including the motion vector of the current coding unit. That is, when the current coding unit inter-encoded, the processor 320 may store the motion vector of the current coding unit twice.

The processor 320 may separately generate additional information including a motion vector for all of the plurality of coding units. The processor 320 may generate additional information on a frame-by-frame basis, but the embodiment is not limited thereto. For example, the processor 320 may generate additional information based on a slice. In this case, the processor 320 may separately generate additional information including a motion vector for all of the plurality of coding units included in the slice, and may include the generated additional information in a header of the slice.

Alternatively, the processor 320 may generate additional information in a plurality of frame units. There is no limitation on the number of motion vectors for a plurality of coding units included in one additional information generated by the processor 320. However, the processor 320 may generate additional information based on the communication state, when the encoded content is transmitted on a real-time basis.

The processor 320 may search for the motion vector corresponding to the current coding unit from the current frame including the current coding unit and the predetermined number of neighboring frames based on the current frame, and add, to the additional information, identification information of at least one frame including a pixel area corresponding to the searched motion vector among the current frame and the neighboring frames.

For example, the processor 320 may search for a motion vector in a neighboring frame as well as a current frame that includes the current coding unit in temporal prediction for the current coding unit. In this case, with only the motion vector, the pixel area that is found to be most similar to the current coding unit may not be displayed. Accordingly, the processor 320 may generate additional information including the motion vector and the identification information of the frame including the pixel area corresponding to the found motion vector.

The processor 320 may search for a motion vector corresponding to the current coding unit, and if the pixel value of the corresponding position between the current coding unit and the pixel area corresponding to the searched motion vector satisfies a preset condition, the processor 320 may add, to additional information, information to use the motion vector of the neighboring coding unit of the current coding unit.

For example, occlusion may occur for reasons such as motion of a person in a specific area within a frame and the pixel data of the specific coding unit may be temporarily varied. In particular, if there is a limitation in the temporal prediction frame and area of the current coding unit, an area where the difference of the pixel data with the current coding unit is large may be searched. The processing device 200 performing the decoding described below, when an error occurs, replaces the current coding unit with the pixel region corresponding to the motion vector included in the additional information, and when the difference in pixel data values between the current coding unit and the pixel area corresponding to the motion vector is large, the viewer may feel a sense of difference. Therefore, in this case, using the peripheral pixel area of the current coding unit rather than the searched pixel area may be a method of reducing the sense of difference. Accordingly, when summed value of all the pixel values of the position corresponding to the pixel area corresponding to the searched motion vector and the current coding unit is greater than a predetermined value, it is also possible to add information to the additional information to use the motion vector of the neighboring coding unit of the current coding unit, instead of the motion vector of the current coding unit.

In the meantime, if the motion vectors for at least two coding units are the same within one frame, the location information for the at least two coding units and the motion vector of one of the at least two coding units may be added to the additional information. That is, the processor 320 may compress the size of the additional information through the operation as described above.

When the motion vectors for the at least two coding units in the area of the preset range are the same within one frame, the processor 320 may add the position information of at least two coding units and one motion vector out of at least two coding units to the additional information. For example, if the motion vectors for at least two consecutive coding units are the same, the processor 320 may add position information for at least two coding units and a motion vector of one of the at least two coding units to the additional information. In this case, the processor 320 may improve the compression efficiency, since only the information about the coding units from the first to the last of the coding units having the same motion vector is added to the additional information.

When a frame including a motion vector for at least two coding units and a pixel area corresponding to the motion vector is the same in one frame, the processor 320 may add, to the additional information, position information of at least two coding units, a motion vector of one of the at least two coding units, and identification information of a frame including a pixel area corresponding to the motion vector.

When regularity between motion vectors for all of the plurality of coding units are detected, the processor 320 may add information corresponding to the detected regularity to the additional information. For example, the processor 320, when the regularity between motion vectors for all of the plurality of coding units is detected, the processor 320 may add information a table or equation corresponding to the detected regularity to the additional information. That is, the processor 320 may compress the size of the additional information through the operation as described above.

The embodiment is not limited thereto, and the processor 320 may detect the regularity between the motion vectors for a part of the plurality of coding units, not all of the plurality of coding units.

Although not illustrated in FIG. 3, the processing device 100 further includes an interface (not shown), and may communicate with the processing device 200 for performing decoding through interface which will be described later. The processor 320 may transmit, to the processing device 200 for performing decoding, the encoded bit stream, motion vector, and additional information, or the like, through the interface.

Interface may perform communication with the processing device 200 for performing decoding, using wired/wireless local area network (LAN), wide area network (WAN), Ethernet, Bluetooth, Zigbee, Institute of Electrical and Electronics Engineers (IEEE) 1394, Wi-Fi, or power line communication (PLC), or the like.

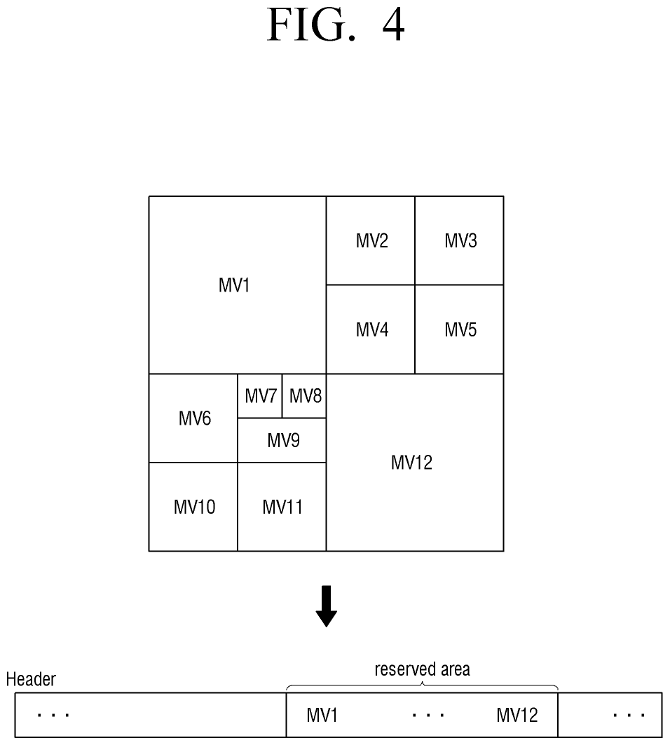

FIG. 4 is a view to describe a method for generating additional information according to an embodiment.

As illustrated in an upper portion of FIG. 4, the processor 320 may divide the frame forming the video content into a plurality of coding units. For example, the processor 320 may divide the frame into 12 coding units. However, this is merely one embodiment, and the processor 320 may divide the number of plurality of coding units to be different for each frame.

The processor 320 may add additional information including the motion vector obtained during an encoding process for each of the plurality of coding units to the encoded frame. For example, as illustrated in the bottom of FIG. 4, the processor 320 may include additional information in a reserved area of the header corresponding to the encoded frame. Here, the additional information included in the reserved area of the header may include motion vectors MV1-MV12 for all of the plurality of coding units.

In the meantime, the processor 320 may include only the motion vector for a coding unit that is greater than or equal to a predetermined size of the plurality of coding units to the additional information. For example, the processor 320 may, among a plurality of coding units, include only MV1 and MV12, which are the motion vectors of the first coding unit and the last coding unit that are larger than a predetermined size of the plurality of coding units, to the additional information.

That is, the processor 320 may further store only the motion vector of the coding unit of a size that may be discerned by the eyes of a viewer, without further storing the motion vector of the small-sized coding unit that is difficult to be discerned by the eyes of the viewer. The processing device 200 performing the decoding may restore the coding unit that may not be decoded according to the related-art, when decoding of a small-sized coding unit is not possible. In this case, the viewer may not feel the sense of difference because the size of the coding unit that may not be decoded is very small. In contrast, the processing device 200 for performing the decoding may, if the decoding of the coding unit of which size is greater than or equal to a predetermined size is not possible, restore the coding unit which is not capable of performing the decoding using the motion vector stored in the additional information. In this case, the restoration performance is improved over the related-art and thus, the sense of difference which the user may feel may be minimized.

The processor 320 may sequentially include a bit string for a motion vector for a coding unit over a predetermined size of the plurality of coding units to the header. In addition to the above example, the processor 320 may include the bit strings of MV1 and MV12 in the header without an identifier for a separate coding unit. In this case, the processing device 200 performing the decoding may determine that the first motion vector in the bit string is MV1 and that the second motion vector is MV12, based on the size information of the plurality of coding units stored in the header.

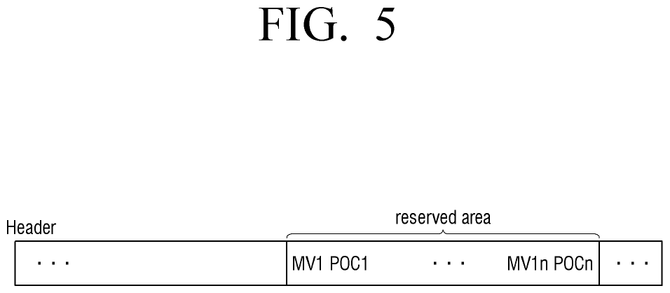

FIG. 5 is a view to describe a method for generating additional information according to another embodiment.

The processor 320 may search for a motion vector corresponding to the current coding unit in the current frame and a preset number of neighboring frames based on the current frame, and add identification information, to the additional information, of the at least one frame including the pixel area corresponding to the motion vector in the current frame and the neighboring frames.

In the temporal prediction, the more frames are to be searched, the higher the accuracy of the search would be. Accordingly, the processor 320 may include the previous frame or the frame after the frame including the current coding unit as the search target, instead of targeting only the previous frame of the frame including the current coding unit. In this case, an error may occur when only the motion vector of the searched pixel area is stored, and the processor 320 may additionally include identification information of a frame including the searched pixel area in additional information.

The processor 320 may sequentially include a first motion vector for a first coding unit, a frame including a pixel area corresponding to the first motion vector, a second motion vector, a frame including a pixel region corresponding to the second motion vector, . . . , the n^{th} motion vector, the frame including the pixel area corresponding to the n^{th} motion vector in the additional information. The embodiment is not limited thereto, and the processor 320 may generate additional information in any number of different orders.

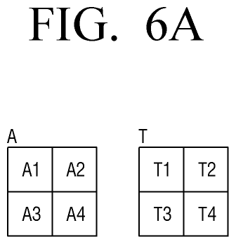

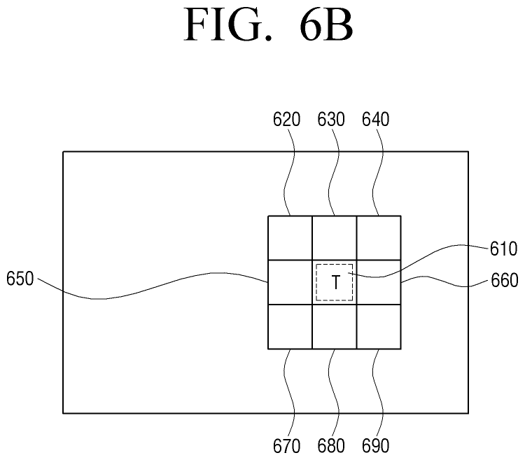

FIG. 6A and FIG. 6B are views to describe a case where occlusion occurs according to an embodiment. As described above, when the occlusion occurs, it may be efficient to use a peripheral pixel area of the current coding unit, rather than the searched pixel area.

As illustrated in FIG. 6A, the processor 320 may compare the current coding unit T and the searched pixel area A corresponding to the current coding unit T. In addition, the processor 320 may can calculate a difference in pixel values of a corresponding position between the current coding unit T and the searched pixel area A. For example, the processor 320 may calculate the difference A1−T1 of the pixel value of the left top pixel and calculate the difference in pixel values of the remaining pixels.

The processor 320 may add all the difference in pixel values of the four pixel areas, and if the sum is greater than a predetermined value, the processor 320 may determine that the difference between the current coding unit T and the searched pixel area A is large. In this case, as illustrated in FIG. 6B, the processor 320 may add the information of using the motion vector of the neighboring coding units 620-690 of the current coding unit T to the additional information.

In addition, when the pixel value of the corresponding position between the pixel area A and the current coding unit T corresponding to the searched motion vector satisfies a preset condition, the processor 320 may compare the current coding unit T and each of the neighboring coding units 620-690 of the current coding unit T. The comparison method may be the same as the method of comparing the current coding unit T with the searched pixel area A.

For example, the processor 320 may calculate the difference of the pixel value of the corresponding position between the current coding unit T and the neighboring coding unit 620, and calculate the sum of all the calculated differences. In addition, the processor 320 may repeat the same calculation for the remaining neighbor coding units 630-690. Finally, the processor 320 may calculate eight sums, and determine a neighboring coding unit that corresponds to the smallest sum of the eight sums. The processor 320 may add the information to use the motion vector of the determined neighboring coding unit among the plurality of neighboring coding units 620-690, instead of the motion vector of the current coding unit T, to the additional information.

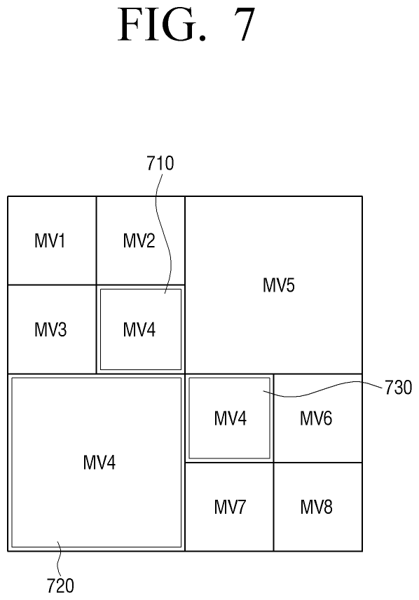

FIG. 7 is a view to describe a method for reducing data amount of additional information according to an embodiment.

The processor 320, when the motion vector for at least two coding units is the same in one frame, may add the position information on the at least two coding units and the motion vector of one of the at least two coding units to the additional information.

For example, as illustrated in FIG. 7, the processor 320 may add, to the additional information, MV4 and the position information for three coding units of which the motion vector is the same as MV4, among ten coding units.

When the motion vectors for the at least two consecutive coding units are the same, the processor 320 may add, to the additional information, the position information about the at least two consecutive coding units and the motion vector of one of the at least two consecutive coding units.

When the motion vector of at least two coding units is the same even in the plurality of frames, instead of one frame, the processor 320 may add, to the additional information, the position information of at least two coding units and the motion vector of one of the at least two coding units.

When the regularity between the motion vectors for all of the plurality of coding units is detected, the processor 320 may add the information corresponding to the detected regularity to the additional information.

For example, when the linearity among the motion vectors for all of the plurality of coding units is detected, the processor 320 may add, to the additional information, an equation representing the linearity, and add, to the additional information, information on the coding unit to which the added equation is applied.

The embodiment is not limited thereto, and the processor 320 may generate a table and add the table in the additional information.

The processor 320 may repeat the above process for the plurality of coding units forming the entire frame and generate the additional information.

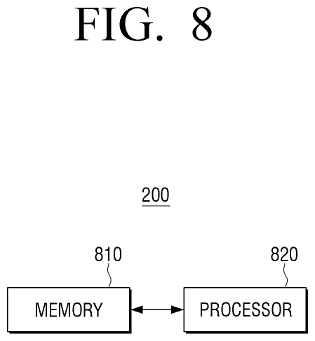

FIG. 8 is a simplified block diagram to describe a processing device 200 performing decoding according to an embodiment.

As illustrated in FIG. 8, the processing device 200 includes a memory 810 and a processor 820.

The memory 810 is separately provided from the processor 820 and may be implemented as a hard disc, a non-volatile memory, a volatile memory, or the like.

The memory 810 may store the encoded video content, the reference frame, or the like. Here, the reference frame may be a restored frame of the frame encoded by the processor 820.

The memory 810 may store all of the encoded video content or a portion of the encoded video content that is streamed from the processing device 100 performing encoding, or the like, on a real-time basis. In this case, the memory 810 may store a part of the encoded video content which is received on a real-time basis, and delete the data of the displayed video content.

The processor 820 controls overall operation of the processing device 100.

The processor 820 may generate a decoded frame by performing decoding in a coding unit for the encoded frame forming the encoded video content. Here, the encoded video content may be a content to which additional information including the motion vector obtained in the encoding process for each of the plurality of coding units forming the encoded frame is added for each encoded frame.

When decoding of the current coding unit is impossible, the processor 820 may obtain the motion vector for the current coding unit from the additional information, and perform decoding by replacing the current coding unit with a pixel region corresponding to the obtained motion vector.

For example, when decoding of the current coding unit is not possible, such as the case where communication is temporarily broken and specific data is not received, or specific data is damaged, the processor 820 may obtain the motion vector for the current coding unit from the additional information, and replace the current coding unit with a pixel region corresponding to the obtained motion vector, and perform decoding.

Here, the additional information may include the motion vector for all of the plurality of coding units. The embodiment is not limited thereto, and the additional information may include the motion vector for a portion of the plurality of coding units. In addition, the additional information may include the information on the motion vector for all of the plurality of coding units in a deformed state.

The additional information may be included in a reserved area of the header corresponding to the encoded frame. The embodiment is not limited thereto and once the additional information is included separately from the data area, any area is available. That is, the motion vector included in the additional information may be stored separate from the motion vector stored in the inter encoding process. In addition, the motion vector may be separately stored for the intra-encoded coding unit as well.

The additional information may include identification information of at least one frame including a pixel area corresponding to the motion vector, and when decoding of the current coding unit is not possible, the processor 820 may obtain the motion vector and identification information for the current coding unit from the additional information, replace the current coding unit with a pixel area corresponding to the motion vector obtained from a frame corresponding to the obtained identification information, and perform decoding.

The additional information may include information to use the motion vector of the neighboring coding unit of the current coding unit, and the processor 820, when decoding of the current coding unit is not possible, may obtain the information to use the motion vector of the neighboring coding unit of the current coding unit from the additional information, replace the current coding unit with a pixel area corresponding to the motion vector of the neighboring coding unit based on the obtained information, and perform decoding.

In the meantime, the additional information may include position information for at least two coding units of which the motion vector is the same and one motion vector of at least two coding units, and the processor 820, when decoding of the current coding unit is not possible, may perform decoding by replacing the current coding unit with a pixel area corresponding to one motion vector of at least two coding units based on the position information.

The additional information may include the information corresponding to the regularity among the motion vectors for all of the plurality of coding units, and the processor 820, if decoding of the current coding unit is not possible, may perform decoding by obtaining the motion vector corresponding to the current coding unit based on the information corresponding to the regularity, and replacing the current coding unit with a pixel area corresponding to the obtained motion vector.

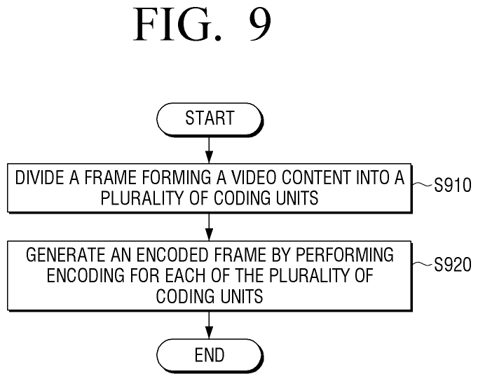

Though not illustrated in FIG. 9, the processing device 200 may further include an interface (not shown), and communicate with the processing device 100 performing decoding through the interface. The processor 820 may receive, from the processing device 100 performing encoding, the encoded bit stream, motion vector, additional information, or the like, through the interface.

The interface may communicate with the processing device 100 performing encoding using wired/wireless LAN, WAN, Ethernet, Bluetooth, Zigbee, IEEE 1394, Wi-Fi, PLC, or the like.

FIG. 9 is a flowchart to describe a control method of a processing device performing encoding according to an embodiment. Here, the processing device may include a memory and a processor.

A frame forming a video content is divided into a plurality of coding units in step S910. By performing encoding for each of the plurality of coding units, an encoded frame is generated in step S920.

The step of generating the encoded frame in step S920 may add additional information including the motion vector obtained in the encoding process for each of the plurality of coding units to the encoded frame.

Here, the additional information may include the motion vector for all of the plurality of coding units. The additional information may be included in the reserved area of the header corresponding to the encoded frame.

The generating the encoded frame in step S920 may include searching for the motion vector corresponding to the current coding unit in the current frame including the current coding unit and the neighboring frames in the predetermined number based on the current frame and adding, to the additional information, identification of at least one frame including a pixel area corresponding to the searched motion vector among the current frame and the neighboring frames.

The generating the encoded frame in step S920 may include the searching the motion vector corresponding to the current coding unit and, based on a pixel value of a corresponding position between a pixel area corresponding to the searched motion vector and the current coding unit satisfying a preset condition, adding, to the additional information, information to use the motion vector of the neighboring coding unit of the current coding unit.

Alternatively, the generating the encoded frame in step S920, when the motion vector for at least two coding units is the same in one frame, may include adding, to the additional information, the position information for the at least two coding units and the motion vector of one of the at least two coding units.

Alternatively, the generating the encoded frame in step S920 may, based on regularity between the motion vectors for all of the plurality of coding units being detected, include adding the information corresponding to the detected regularity to the additional information.

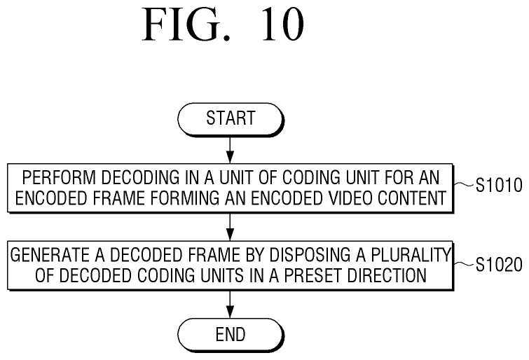

FIG. 10 is a flowchart to describe a control method of a processing device performing decoding according to an embodiment. Here, the processing device may include a memory and a processor.

For the encoded frame forming the encoded video content, decoding is performed in a coding unit in step S1010. By disposing a plurality of coding units for which decoding is performed in a predetermined direction, a decoded frame is generated in step S1020. Here, in the encoded video content, additional information including the motion vector obtained in the encoding process for each of a plurality of coding units forming the encoded frame may be added for each of the encoded frames.

The step of performing decoding in step S1010 may include performing decoding by, when decoding of the current coding unit is not possible, obtaining a motion vector for the current coding unit from the additional information, and replacing the current coding unit with a pixel area corresponding to the obtained motion vector.

Here, the additional information may include the motion vector for all of the plurality of coding units. In addition, the additional information may be included in a reserved area of the header corresponding to the encoded frame.

In the meantime, the additional information may include identification of at least one frame including the pixel area corresponding to the motion vector, and the step of performing decoding in step S1010 may include performing decoding by obtaining the motion vector and identification information for the current coding unit from the additional information, and replacing the current coding unit with the pixel area corresponding to the motion vector obtained from the frame corresponding to the obtained identification information.

Alternatively, the additional information may include information to use the motion vector of the neighboring coding unit of the current coding unit, and the step of performing decoding in step S1010 may include, when it is not possible to decode the current coding unit, performing decoding by obtaining the information to use the motion vector of the neighboring coding unit of the current coding unit from the additional information, and replacing the current coding unit with a pixel area corresponding to the motion vector of the neighboring coding unit based on the obtained information.

Alternatively, the additional information may include position information of at least two coding units of which the motion vector is the same and motion vector of one of the at least two coding units, and the step of performing decoding in step S1010 may, when decoding of the current coding unit is not possible, perform decoding by replacing the current coding unit with a pixel area corresponding to one motion vector of at least two coding units based on the position information.

Alternatively, the additional information may include information corresponding to the regularity between the motion vectors for all of the plurality of coding units, and the step of performing decoding in step S1010 may include, when decoding of the current coding unit is not possible, performing decoding by obtaining the motion vector corresponding to the current coding unit based on the information corresponding to the regularity and replacing the current coding unit with a pixel area corresponding to the obtained motion vector.

According to the various embodiments, the processing devices may add the motion vector for each of the plurality of coding units forming the frame to the encoded frame, and improve restoration efficiency using the same, when an error occurs.

The methods according to the various embodiments may be programmed and stored in various storage media. Accordingly, the methods according to the various embodiments described above may be implemented by various types of electronic devices executing the storage medium.

A non-transitory computer readable medium which stores a program for sequentially executing a method for controlling according to an embodiment may be provided.

The non-transitory computer-recordable medium is not a medium configured to temporarily store data such as a register, a cache, or a memory but an apparatus-readable medium configured to semi-permanently store data. Specifically, the non-transitory apparatus-readable medium may be a compact disc (CD), a digital versatile disc (DVD), a hard disc, a Blu-ray disc, a universal serial bus (USB), a memory card, a read only memory (ROM), and the like.

While one or more embodiments have been described with reference to the figures, it will be understood by those of ordinary skill in the art that various changes in form and details may be made therein without departing from the spirit and scope as defined by the following claims and their equivalents.

1. A processing device comprising:
a memory storing a video content; and
a processor configured to:
divide a frame forming the video content into a plurality of coding units, and generate an encoded frame by performing encoding for each of the plurality of coding units,
wherein the processor is configured to add information including a motion vector that is obtained in the encoding process for each of the plurality of coding units to the encoded frame.

2. The processing device of claim 1, wherein the additional information comprises a motion vector for all of the plurality of the coding units.

3. The processing device of claim 1, wherein the additional information is included in a reserved area of a header that corresponds to the encoded frame.

4. The processing device of claim 1, wherein the processor is configured to:
searching for, from a current frame including a current coding unit and a predetermined number of neighboring frames based on the current frame, a motion vector corresponding to the current coding unit, and adding, to the additional information, identification information of at least one frame including a pixel area corresponding to the searched motion vector among the current frame and the neighboring frames.

5. The processing device of claim 1, wherein the processor is configured to:
searching for a motion vector corresponding to a current coding unit and, based on a pixel value of a corresponding position between a pixel area corresponding to the searched motion vector and the current coding unit satisfying a preset condition, adding, to the additional information, information to use a motion vector of a neighboring coding unit of the current coding unit.

6. The processing device of claim 1, wherein the processor is configured to, based on a motion vector for at least two coding units being identical in one frame, adding, to the additional information, position information on the at least two coding units and a motion vector of one of the at least two coding units.

7. The processing device of claim 1, wherein the processor is configured to, based on regularity between the motion vectors for all of the plurality of coding units being detected, adding, to the additional information, information corresponding to the detected regularity.

8. A processing device comprising:
a memory storing an encoded video content; and
a processor configured to generate a decoded frame by performing decoding for an encoded frame forming the encoded video content in a coding unit, and
wherein the encoded video content is added with additional information including a motion vector obtained in an encoding process for each of a plurality of coding units forming the encoded frame by each of the encoded frames,
wherein the processor is configured to:
based on decoding of a current coding unit not being possible, perform decoding by obtaining a motion vector for the current coding unit from the additional information and replacing the current coding unit with a pixel area corresponding to the obtained motion vector.

9. The processing device of claim 8, wherein the additional information comprises a motion vector for all of the plurality of coding units.

10. The processing device of claim 8, wherein the additional information is included in a reserved area of a header corresponding to the encoded frame.

11. The processing device of claim 8, wherein the additional information includes identification information of at least one frame including a pixel area corresponding to the motion vector, and the processor may, based on decoding of the current coding unit not being possible, perform decoding by obtaining a motion vector and identification information for the current coding unit from the additional information and replacing the current coding unit with a pixel area corresponding to the obtained motion vector in the frame corresponding to the obtained identification information.

12. The processing device of claim 8, wherein the additional information includes information to use a motion vector of a neighboring coding unit of the current coding unit, and the processor may, based on decoding of the current coding unit not being possible, perform decoding by obtaining information to use a motion vector of a neighboring coding unit of the current coding unit from the additional information, and replacing the current coding unit with a pixel area corresponding to a motion vector of the neighboring coding unit based on the obtained information.

13. The processing device of claim 8, wherein the additional information includes position information of at least two coding units of which a motion vector is identical and a motion vector of one of the at least two coding units, and the processor may, based on decoding of the current coding unit not being possible, perform decoding by replacing the current coding unit with a pixel area corresponding to a motion vector of the at least two coding units based on the position information.

14. The processing device of claim 8, wherein the additional information includes information corresponding to regularity between motion vectors for all of the plurality of coding units, and the processor may, based on decoding of the current coding unit not being possible, perform decoding by obtaining a motion vector corresponding to the current coding unit based on information corresponding to the regularity and replacing the current coding unit with a pixel area corresponding to the obtained motion vector.

15. A control method of a processing device, comprising:
dividing a frame forming a video content into a plurality of coding units; and
generating an encoded frame by performing encoding for each of the plurality of coding units,
wherein the generating the encoded frame comprises adding information including a motion vector that is obtained in the encoding process for each of the plurality of coding units to the encoded frame.
